(19) United States
(12) Patent Application Publication
(10) Pub. No.: US 2026/0368484 A1
(43) Pub. Date: Nov. 19, 2026

(54) SEMANTICS-AWARE TABULAR FOUNDATION MODEL

(71) Applicant: SAP SE, Walldorf (DE)

(72) Inventors: Marco Spinaci, Versailles (FR); Marek Polewczyk, Berlin (DE); Maximilian Schambach, Berlin (DE); Sam Thelin, Stuttgart (DE)

(21) Appl. No.: 19/206,919

(22) Filed: May 13, 2025

(51) Int. Cl. G06N 3/045; G06F 40/30; G06N 3/048

(52) U.S. Cl. CPC G06N 3/045; G06F 40/30; G06N 3/048

(57) ABSTRACT

In an example embodiment, categorical encodings in TabPFN and similar structural prediction models are replaced using text embeddings derived from cell values using a large language model. This approach captures the semantic meaning of categories across different tables and semantic similarities between categories and enhances model predictive performance. Moreover, it allows knowledge transfer across domains with different but semantically related categories.

### TECHNICAL FIELD

This document generally relates to computer systems. More specifically, this document relates to a semantic-aware tabular foundation model.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a diagram illustrating a TabPFN-based foundation model.

FIG. 2 is a block diagram illustrating a system, in accordance with an example embodiment.

FIG. 3 illustrates a machine learning system, according to some examples.

FIG. 4 is a flowchart depicting a machine learning pipeline, according to some examples.

FIG. 5 is a system architecture diagram showing a layered view of an AI integrated system, according to some examples.

FIG. 6 is a flow diagram illustrating a method for using a neural network to predict values in structural data, in accordance with an example embodiment.

FIG. 7 shows a block diagram showing one example of a software architecture for a computing device.

FIG. 8 shows a block diagram of a machine in the example form of a computer system within which instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

LLMs typically utilize a transformer architecture (described in more detail below) to generate predicted output. While this approach works well for unstructured data, such as text, there are technical issues that impede their ability to efficiently process tabular data. Tabular data is highly structured in that the data is stored in the form of tables, such as database tables. Each table comprises at least two columns and at least one row. In some instances, it is desirable to predict values for cells in such tables using the values in other cells. This could be useful in forecasting future values for given data or even just filling in cells that, for one reason or another, are missing values (such as from a data entry error).

More specifically, using transformer-based models to predict values in tabular data using in-context learning is limited by the quadratic time complexity and memory consumption (as a function of dataset size or context length) of transformer models, due to a concept called “self-attention.” Self-attention is a mechanism that allows the model to weigh the importance of different words (or tokens) in a sequence relative to each other when processing or generating text. It is a way for the model to determine how much attention each word should pay to all other words in a sentence, which helps capture relationships between distant words.

Self-attention, however, causes a dramatic increase in quadratic time complexity of a model because it computes pairwise interactions between all tokens in an input sequence. Specifically, for each word or token in a sequence, the model computes attention scores with every other word or token in the sequence. Additionally, once the context has been processed, then during inference the entire context has to be scanned to produce a prediction on an unseen example. Both of these issues are dramatically increased when dealing with tabular data, making transformer-based models inefficient when tabular data is processed as context. When predicting with a transformer on individual records (zero-shot), this may not be much of an issue, but it is an issue for in-context-based (many-shot) predictions.

One approach for implementing a transformer-based model for processing tabular data is known as a Tabular Prior-Data Fitted Network (TabPFN). The core idea behind TabPFN is to use a pretraining approach, similar to how models like Generative Pre-trained Transformer (GPT) or Bidirectional Encoder Representations from Transformers (BERT) work for text. During the pretraining phase, the model learns patterns, relationships, and feature representations from a wide variety of tabular datasets, including synthetic data sets. This allows it to capture useful knowledge that can be transferred to new tasks, even with smaller datasets.

Once pretrained, the model can be applied to a specific dataset via in-context learning for a particular task, such as classification or regression. This process adapts the learned features to the new task, making the model more effective and efficient, even when there is limited data available. Alternatively, the model could be further adapted by fine-tuning on specific dataset and task.

Because TabPFN learns feature transformations during pretraining, it can process data in a way that's more flexible and powerful than traditional machine learning models, which often require manual feature extraction. It can be applied to a variety of problems involving tabular data, such as predicting sales, diagnosing medical conditions, or any task requiring structured data.

Despite advances, current systems often face general challenges when addressing the comprehensive range of information contained in tabular data. A common challenge in this field is effectively encoding categorical values, which are typically represented as integers. More specifically, categorical values are encoded as integers since TabPFN only processes numerical input. For example, the unique classes of a category such as “animal” may include “dog”, “cat”, and “mouse” which may be mapped to 0, 1, and 2, respectively. This approach can overlook the semantic relationships between categories. For example, if the category is “dog breed,” an integer mapping of 0 may be applied to a “Cocker Spaniel” value, an integer mapping of 1 may be applied to a “Doberman” value, and an integer mapping of 2 may be applied to a “Cavalier King Charles Spaniel” value. These mappings, however, do not reflect the semantic similarities between Cocker Spaniels and Cavalier King Charles Spaniels, and how different both of these breeds are to Dobermans.

Moreover, the mapping of categories to categorical values (indices) is arbitrary for each table. Thus, the same categories may be assigned to different values in different tables. This further degrades the ability of the model to deduce semantic meaning of categories and semantic relationships among them.

In scenarios where the semantic properties of table elements are of significant importance, conventional numerical mappings may introduce inconsistencies or require computationally intensive measures to adjust for arbitrary ordering. Such limitations can necessitate additional processing steps to maintain accuracy, thereby increasing runtime and complexity. The challenges involved in capturing these nuanced relationships underscore the methodologies that more fully integrate semantic awareness into the processing of tabular data.

Additionally, the arbitrary mapping of categories to indices and of columns to indices causes some further drawbacks. First, the model's result is non-deterministic based on how data is fed to it. The model's result will be different for different category to index and column to index mapping. Therefore, changing the order of the feature columns will modify the result, and thus if the same table is fed to the model twice, but in one instance two of the columns are reversed, the output of the model will be different, despite the underlying data and underlying semantic meaning being the same. While in some cases this issue may be ameliorated by running the model several times, each time shuffling the mappings at random, and averaging the results, this results in a significantly increased runtime.

Second, there is a hard limit on the number of supported different target classes This may be mitigated via performing a multi-step classification, but this is slower and adds further arbitrariness in how to group classes together.

What is needed is a solution that provides a true foundation model that comprehends the meaning of values within tables. Specifically, by predicting values on data distribution across contextual rows but also by accurately identifying patterns through semantic knowledge gained from processing various tables.

As mentioned briefly before, TabPFN is a transformer-based foundation model approach for in-context learning on tabular data. Synthetic data is used to train a transformer backbone to produce a foundation model. At inference time, training data and query samples are fed into the foundation model in a single forward pass. The training data is considered the context, and the query samples (or test data) are fed with it in that single forward pass.

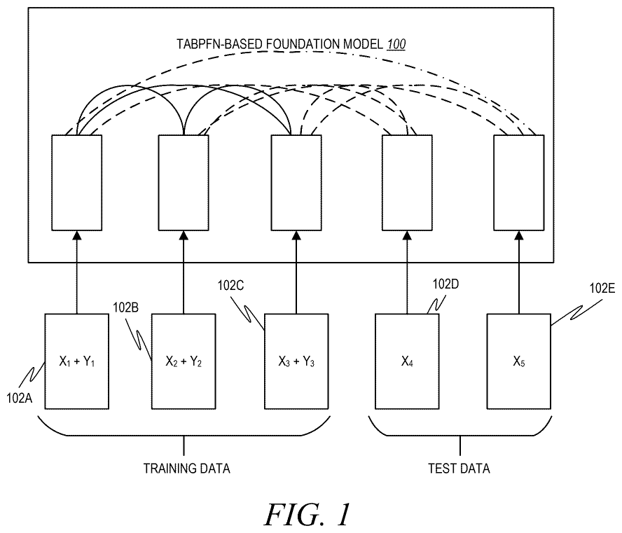

FIG. 1 is a diagram illustrating a TabPFN-based foundation model 100. Here, training data 102A, 102B, 102C is combined with test data 102D, 102E and fed to the TabPFN-based foundation model 100 in a single forward pass. The TabPFN-based foundation model 100 then computes pairwise interactions via multi-head self-attention between each pair of input data 102A, 102B, 102C, and between test data 102D and 102E and those input data. Here, the solid lines represent the interactions among pairs of training data 102A, 102B, 102C while the dashed lines represent the interactions among pairs of test data 102D, 102E and training data 102A, 102B, 102C. Each piece of training data 102A, 102B, 102C may include feature data (represented by x) and target data (represented by y). The target data is the data the TabPFN-based foundation model 100 is trained to predict. The test data 102D, 102E (which could also be query samples or inference-time data) lacks such target data and thus will need it predicted.

Furthermore, the result of feeding the test data 102D, 102E into the TabPFN-based foundation model 100 is a set of probability distributions over values of Y. These probability distributions can then be compared to “ground truth” values of Y from the synthetic dataset, via a cross-entropy loss giving the signal for optimizing/updating the model weights.

In the TabPFN framework, synthetic training data is created using probabilistic modeling and data augmentation techniques. The model leverages probabilistic approaches to generate new data by sampling from learned distributions based on the real dataset. This process often involves conditional probability distributions that are derived from the features and outcomes in the original data. Additionally, Bayesian inference might be employed to model the uncertainty in the data generation, ensuring that the synthetic data is realistic and aligned with the true data distribution while introducing some variations.

To enhance the data, TabPFN also applies data augmentation methods, such as perturbing the features of the original data by making small random changes. This can involve slightly altering numerical values or modifying categorical features, ensuring the changes are still plausible. Another common technique is adding noise to the original data, which helps create variations that improve the robustness of the model. In some cases, generative models like GANs (Generative Adversarial Networks) or VAEs (Variational Autoencoders) might be used, allowing the model to generate synthetic data that closely mimics the real data's distribution.

There are many instances where it is crucial to consider semantics of the feature columns to make a valid prediction. This is very often the case when values in each column are unique, or nearly unique. For example, a table column might contain the name of a country. Some countries might not appear at all in the context rows, but only in the query rows. In such cases, in order to make a good prediction of the y target, it is crucial to make use of the semantic value of the cell to understand which rows have “semantically similar” countries, and which do not. For a concrete example, consider the following table, where the purpose is to predict whether a certain whisky is appreciated by critics. Suppose the following rows are used for context:

| Whiskey | Cost | Class | Cluster | Country | Type | Critic Score |
|---|---|---|---|---|---|---|
| Highland | Over 300 | SingleMalt- | Full- | Scotland | Malt | 1.0 |
| Park 30 yo | CAD | like | bodied, | | | |
| | | | sweet, | | | |
| | | | pronounced | | | |
| | | | sherry, | | | |
| | | | fruity | | | |
| Catto's | Between | Scotch-like | None | Scotland | Blend | 0.0 |
| 12 yo | 30 and | | | | | |
| | 50 CAD | | | | | |
| Aberlour | Between | SingleMalt- | Full- | Scotland | Malt | 1.0 |
| A'Bunadh | 70 and | like | bodied, | | | |
| (Batch | 125 | | sweet, | | | |
| 37) | CAD | | pronounced | | | |
| | | | sherry, | | | |
| | | | fruity | | | |
| Bowmore | Between | SingleMalt- | Medium- | Scotland | Malt | 0.0 |
| Legend | 30 and | like | bodied, | | | |
| | 50 CAD | | medium- | | | |
| | | | sweet, | | | |
| | | | smoky, | | | |
| | | | medicinal | | | |
| AnCnoc | Between | SingleMalt- | Full- | Scotland | Malt | 1.0 |
| Cutter | 70 and | like | bodied, | | | |
| | 125 | | dry, very | | | |
| | CAD | | smoky, | | | |
| | | | pungent | | | |

Then suppose the following query rows are to be predicted:

| Whiskey | Cost | Class | Cluster | Country | Type | Critic Score |
|---|---|---|---|---|---|---|
| Aberlou | Between | SingleMalt- | Full- | Scotland | Malt | To be |
| A'Bunadh | 70 and | like | bodied, | | | predicted |
| (Batch 39) | 125 | | sweet, | | | |
| | CAD | | pronounced | | | |
| | | | sherry, | | | |
| | | | fruity | | | |
| Old | Between | Bourbon- | High Rye | USA | Bourbon | To be |
| Grand- | 30 and | like | whiskey | | | predicted |
| Dad | 50 CAD | | | | | |
| Bourbon | | | | | | |
| (80/86 | | | | | | |
| Proof) | | | | | | |
| Jefferson's | Between | Bourbon- | High Rye | USA | Bourbon | To be |
| Very | 30 and | like | whiskey | | | predicted |
| Small | 50 CAD | | | | | |
| Batch | | | | | | |
| Bourbon | | | | | | |
| Heaven | Less | Bourbon- | LowRye | USA | Bourbon | To be |
| Hill Old | than 30 | like | whiskey | | | predicted |
| Style | CAD | | | | | |
| Bourbon | | | | | | |
| (white | | | | | | |
| label) | | | | | | |
| Virginia | Between | Bourbon- | Standard | USA | Bourbon | To be |
| Black | 30 and | like | Rye | | | predicted |
| | 50 CAD | | whiskey | | | |

Here, the Whiskey column comprises unique entries. Using traditional techniques, each of these entries would be assigned to a different integer. However, some of the entries have similar names. For example, there are two different Aberlour A'Bunadh entries. This is useful information that would be helpful to be exploited in any prediction to be made, but the traditional indexing scheme cannot capture this information as these entries are treated as dissimilar from each other as they are from other entries.

Additionally, not all values for all categories appear in the context. For example, in the “Cost” column there is no category for “less than 30 CAD;” this category appears only in the query itself. While a traditional model would recognize that the “less than 30 CAD” category is different than the categories in the context, it would not be able to appreciate “how” it is different. Specifically, “less than 30 CAD” means that it is, in fact, the cheapest category. This would be incredibly useful information for the model to have when predicting critic score, especially as in the context data there appears to be a correlation between the price category of the whisky and its critic score.

There are also examples where it is useful to exploit the semantic meaning of the target class. This is not the case in the previous example (where classes are simply marked as 0.0 or 1.0), but this becomes important when there are many possible target classes. In general, it is impossible to predict a class that does not appear in the context at all; however, if a class appears only once or twice, it becomes possible, but extremely hard, using category indexes, as the signals to learn from are too small. If the category names have semantic meaning, however, then signals from different, but semantically similar, categories can also be exploited to improve the prediction.

In an example embodiment, categorical encodings in TabPFN and similar structural predictions models are replaced using text embeddings derived from cell values using a large language model. This approach captures the semantic meaning of categories across different tables and semantic similarities between categories and enhances model predictive performance. Moreover, it allows knowledge transfer across domains with different but semantically related categories.

It should be noted that while tabular data is specifically described throughout this disclosure, one of ordinary skill in the art will recognize that the techniques described herein can be applied to any type of structured data and are not specifically limited to tabular data.

Text embeddings capture semantic similarities between categories based on contextual and linguistic relationships. Words that come from the same category are represented by vectors that are closer to each other than words coming from different categories. Such text embeddings can be obtained by any available embedding language model, such as BERT, that encode text into high-dimensional vectors.

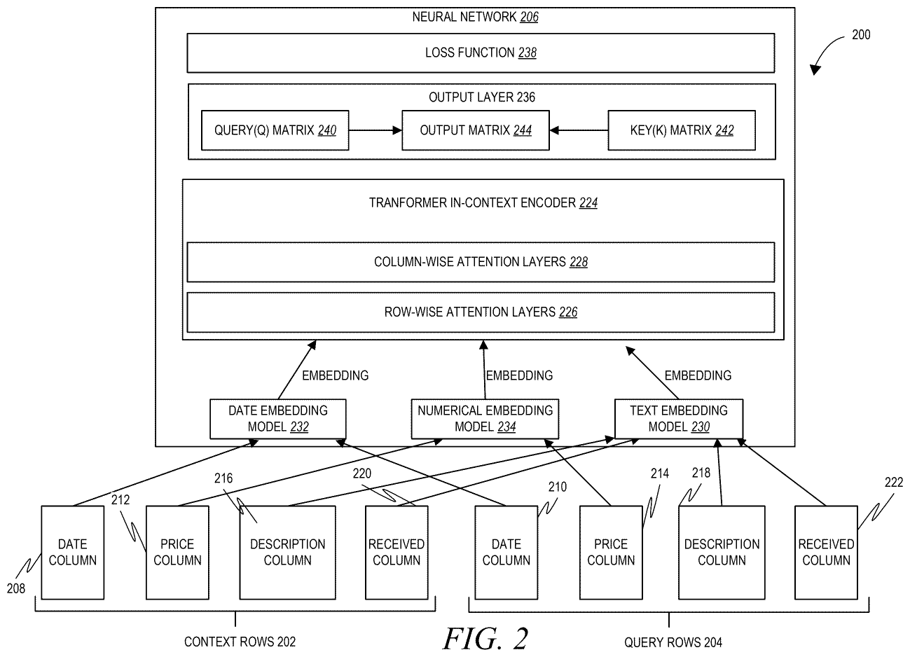

FIG. 2 is a block diagram illustrating a system 200, in accordance with an example embodiment. Here, like in traditional TabPFN, context rows 202 and query rows 204 are fed as input to a neural network 206. Here, both the context rows 202 and the query rows 204 have some columns representing dates, specifically date column 208 and date column 210, some columns representing price, specifically price column 212 and price column 214, some columns representing text descriptions, specifically description column 216 and description column 218, and some columns representing a Boolean, such as received column 220 and received column 222. Generally, each column can generally be thought of as containing a date, numerical data, or text/contextual data. Here, for example, price is numerical data while description and received are both text/contextual data. Of course, the name of each column can also be considered text/contextual data, regardless of the contents of the column.

A transformer in-context encoder 224 treats each table cell as a single token, passing the tokens through a series of interleaved row-wise attention layers 226 and column-wise attention layers 228 to identify relationships between tokens within rows and columns, respectively. Rather than input merely integer embeddings for all types of tabular data, columns representing text/contextual data are first passed through a text embedding model 230 to generate a vector embedding for each cell. These text embeddings represent the categories of the values in the cells and also capture the semantic meaning and relationships among the values.

In some example embodiments, in addition to the encoding of the values themselves, a column identifier can also be encoded for each column. This may be performed by embedding the text of the column name using, for example, the text embedding model 230.

In an example embodiment, the text embedding model 230 is an LLM. LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance. The bidirectional encoder may be implemented as a Bidirectional Long Short-Term Memory (BiLSTM) or BERT (Bidirectional Encoder Representations from Transformers) model. Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data. LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modeling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

In the present case, an LLM may be used as the text embedding model 230 to produce an embedding for each unique entry in each cell of the input rows (both context and query). In the case of vector embeddings, a vector embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector, and the texts with similar semantics will have the corresponding similar embeddings.

The other types of data values (e.g., dates, numbers) may have their own embedding models. Here, for example, date data is processed by a date embedding model 232 and numerical data is processed by a numerical embedding model 234. The date embedding model 232 splits the date into day, month, and year and then treats each of them as an integer for embedding. For purposes of the present disclosure, the operation of the numerical embedding model 234 is not described in detail as its specific functionality is not relevant to the operation of the text embedding model 230 or the date embedding model 232. All that matters is that the numerical embedding model 234 somehow produces a vector embedding based on the provided number.

Furthermore, the text embedding model 230, date embedding model 232, and numerical embedding model 234 all produce vectors of the same dimension. To aid in this, as described earlier, a linear layer may be used after the text embedding model 230.

As mentioned briefly earlier, the names of columns containing dates or numbers are themselves, still considered text. However, as described earlier, these names may be embedded as positional embeddings. The positional embeddings could be combined with the embedding produced by the corresponding model (text embedding model 230, date embedding model 232, or numerical embedding model 234). This may be performed by, for example, concatenating the embeddings or summing them together.

The embeddings generated by the text embedding model 230, date embedding model 232, and numerical embedding model 234 are passed as input to the transformer in-context encoder 224. This is in contrast to traditional methods where the integer embeddings would be used as the input.

Within the transformer in-context encoder 224, multi-head self-attention is performed. Each embedded row vector could be linearly transformed into three vectors: a query vector, a key vector, and a value vector. The purpose of these vectors is to enable each row to selectively attend to any context (e.g., training) row. Alternatively, each key/value/query vector could be produced for each cell as opposed to each row. Then, in cross-row attention, each query vector is compared against the key vectors in other rows but in the same column.

For any particular row, its query vector will be compared against the key vectors of ows in the sequence, including itself and all training points. This comparison is done using the dot product between the query and each key, producing a score that reflects how relevant or similar each row is to the query row. These scores are then scaled (to keep them numerically stable) and passed through a softmax layer, turning them into attention weights—basically a set of probabilities that say, “this is how much this row cares about each of the other rows.”

These attention weights are then used to take a weighted average of the value vectors of the other rows. The result is a new representation of the query row that incorporates context from all other rows—in other words, it reflects what the model has learned about how this sample might be related to the rest of the data. This same process is happening in parallel for every row in the sequence, not just the query—each row gets its own context-enriched representation.

In multi-head attention, this process happens multiple times in parallel with different learned projections for queries, keys, and values. Each “head” captures different kinds of relationships between rows. One head might learn to focus on feature similarity; another might focus on matching label patterns; another might focus on outliers or other structure. The outputs of all heads are then concatenated and passed through a linear layer, giving a final attention output for each row.

This attention output then flows through standard transformer operations—layer normalization, residual connections, and a feedforward network—before moving to the next transformer layer. Each subsequent layer builds more abstract and refined representations, again using multi-head self-attention to mix information across the dataset.

It should be noted that in some example embodiments, both cross-column and cross-row attention is performed. As such, essentially the entire structure (multi-head attention, possible layer normalization, residual connection, and feedforward network) may be repeated multiple times to capture both cross-column and cross-row attention. When performing cross-column attention, the attention is performed row-by-row across column, with each column attending to any other column.

The ordering of cross-column or cross-row attention is also flexible—either could be performed before the other.

This attention mechanism does not just help the model spot correlations between features—it helps it simulate inference by reasoning about how the label of one point relates to others, across all possible relationships, in a Bayesian sense.

Because attention is permutation-invariant (it does not care about the order of rows), it's very well-suited to tabular data, where the ordering of rows is usually arbitrary.

In a further example embodiment, the architecture is further expanded to eliminate restrictions on the maximum number of target categories by adjusting an output layer 236 and a loss function 238 of the neural network 206. This modification allows the model to predict the similarity between each query row and context row, rather than directly predicting the category for a query row. This approach also avoids encoding context target categories as numerical indices, thus retaining their semantic meaning.

More specifically, the output layer 236 is split into two matrixes, a query matrix (Q) 240 and a key (K) matrix 242, each of shape [batch size, input sequence size, hidden dimension] (for an arbitrary value of hidden dimension), where the input sequence size corresponds to the number of query rows plus the number of context rows. The query matrix 240 contains embeddings produced in Q vectors during the attention stages, while the key matrix 242 contains embeddings produced in K vectors during the attention stages. An attention scoring mechanism is then mimicked by the computing of the matrix of inner products QK^{T}. This results in a matrix of shape (batch size, input sequence size, input sequence size), with the arbitrary value of hidden dimension cancelled out.

In this way, an output matrix 244 is produced that illustrates the similarity between inputs in the sequence, specifically which query rows are similar to which context rows. Ideally, values from 0 to 1 are forced into an array, and for that a sigmoid function and binary cross-entropy are used as the loss function 238. The target is an adjacency matrix that represents which query and context rows are of the same class. The loss is computed elementwise on the two square matrices [the predicted σ(QK^{T}) and the adjacency matrix] and then aggregated (e.g. via sum). During inference, the output through the sigmoid function and since the output should be symmetrical, the output matrix can be added with its transpose and consider entries which are above 1 as true connections [σ(QK^{T})+σ(KQ^{T})≥1].

Alternatively, instead of computing the scalar products QK^{T} and squashing them to the (0, 1) interval via the sigmoid function, one could compute the pairwise cosine similarities between each element of Q and each element of K. Cosine similarity between two vectors is often employed to check for alignment while ignoring the magnitude of the vectors, and results in a number in the (−1, 1) range. During training, this can then still be compared to the original adjacency matrix to compute cross-entropy loss, for example by replacing negative numbers by 0.

Another possible approach during training comprises considering, for each query row, two context rows, one being in the same class and one being in a different class. Then a triplet loss can be applied, that tries to push the vector coming from the query row as close as possible to the context vector from the same class, and far away from that in a different class. Note that in this case it is not necessary to generate two vectors Q and K for each row, but only one embedding vector.

As yet another alternative, after computing the embedding vector of each row, one could construct a representative vector for each class by averaging the context vectors belonging to that class. Then query vectors might be compared to these averaged vector, for example, by cosine similarity. An explicit margin can be factored in the computation, in order to bound the distance between the resulting centroids away from 0, while contextually trying to reduce the distance between query vectors and their corresponding class centroid.

In some example embodiments, the neural network 206 may be deployed as part of an enterprise resource planning (ERP) system. ERP applications are often used in conjunction with a database management application to manage various aspects of business operations. An example ERP software application is the S/4 HANA product available from SAP SE of Walldorf, Germany.

The ERP application generates and utilizes the data stored by the database management application to perform different enterprise operations. For example, an ERP application supporting a human resources operation may store employee records at the database management application. An ERP application supporting accounting may use records managed by the database management application to perform various accounting-related tasks such as generating and recording invoices, purchase orders, and the like. An ERP application supporting human resources management may perform various tasks related to, for example, using data managed by the database management application to generate and manage payroll, benefits, and the like. Other ERP applications may perform other business tasks.

The database management application may store ERP application data in a structured manner. For example, the database management application may implement a data schema including multiple tables. Each table stores data in logical rows and columns.

The ERP system may execute one or more ERP applications on behalf of users. The ERP system may also execute a database management application that may be in communication with a persistent storage. The persistent storage may store structured data, making up a database managed by the database management application. In some examples, the data at the persistent storage may be arranged according to a schema. The schema may define various tables and relationships there between. The tables may comprise records, as described herein.

The ERP applications may be or include any suitable ERP application such as, for example, an operations management application, a human resources application, an accounting application, and/or the like. Example ERP applications include SAP S/4HANA Cloud analytics software solutions such as the SAP® Analytics Cloud application available from SAP SE of Walldorf, Germany, a human capital management software solution such as SAP SuccessFactors®, also available from SAP SE of Walldorf, Germany, a project management software solution such as SAP Portfolio and Project Management (PaPM), also available from SAP SE of Walldorf, Germany.

Users may access the ERP system to use the ERP applications. In some examples, users access the ERP computing system with user computing devices. The user computing devices may be or include any suitable computing device such as a mobile computing device, a laptop computing device, a desktop computing device, and/or the like.

The ERP computing system may be implemented in an on-premises and/or in a cloud environment. When the ERP computing system is implemented in an on-premises environment, a customer enterprise may obtain software for executing the ERP applications, and the database management application from a software provider enterprise. The customer enterprise may maintain computer hardware for implementing the ERP system, for example, on the customer enterprise's own premises.

In a cloud environment, a hyperscaler or other cloud service provider provides computing hardware for executing the ERP applications and database management application and implementing persistent storage. Users access the ERP applications and database management application at the provided computing hardware, which may be referred to as a cloud environment.

A cloud environment may be a public cloud environment or a private cloud environment. In a private cloud environment, the customer enterprise may provide executables and other files to implement the ERP applications and database management application to the cloud service provider. In a public cloud environment, users associated with the customer enterprise are provided with access to the ERP system through one of a number of tenancies. The software provider enterprise may provide executables and other files to implement the ERP system and, in some examples, may also maintain the ERP computing system and the various tenancies. For example, users may be associated with one customer enterprise having a first tenancy at a public cloud environment. The users may have access to the ERP applications and database management application. Other users associated with other customer enterprises holding other tenancies may have access to other instances of the ERP applications also executing at the public cloud environment.

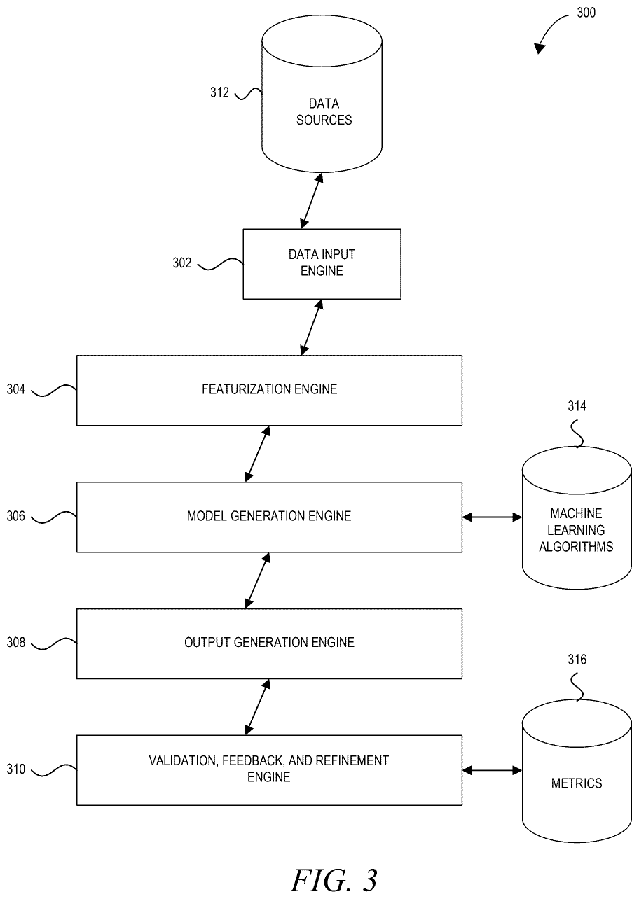

The neural network 206 may be deployed as part of a machine learning system. FIG. 3 illustrates a machine learning system 300, according to some examples. The machine learning system 300 may be used to implement aspects of the present disclosure. The machine learning system 300 is shown to include a data input engine 302, a featurization engine 304, a model generation engine 306, an output generation engine 308, and a validation, feedback, and refinement engine 310.

The data input engine 302 may be configured to access, interpret, request, format, re-format, or receive input data from data sources 312. Data sources 312 may include training data (e.g., data for training machine learning models), validation data (e.g., data for comparing model output with known results to evaluate performance), or reference data (e.g., data used to establish baselines or inform model creation). The data input engine 302 can interact with external data systems via input/output (I/O) devices, network interfaces, or storage elements to ensure input data is processed and stored in a suitable format for further operations.

The featurization engine 304 may be configured to transform input data into features that are optimized or useful for machine learning. The featurization engine 304 can handle feature extraction, scaling, or selection, enabling the machine learning system 300 to identify and process relevant data attributes for subsequent modeling. For example, features extracted from raw data may be annotated, labeled, or transformed into numerical representations suitable for machine learning algorithms 314. The featurization engine 304 can work iteratively with other components to refine features based on model requirements or outcomes.

The model generation engine 306 is responsible for creating, training, and configuring one or more machine learning models based on input data and selected features. The model generation engine 306 may include functionality for model selection, hyperparameter tuning, or algorithm implementation.

Machine learning broadly involves using computer algorithms to automatically learn patterns and/or relationships in data, often without the need for explicit programming.

The model generation engine 306 may also support iterative model refinement and validation cycles, enabling adaptability to evolving data or performance criteria.

In some examples, the output generation engine 308 is responsible for model inference. The output generation engine 308 processes data to produce predictions, classifications, or other results. The output generation engine 308 can also apply post-processing techniques such as aggregation, thresholding, or confidence scoring to ensure outputs are in a format suitable for downstream systems or user interpretation.

The validation, feedback, and refinement engine 310 may be configured to validate, monitor, or improve the performance and relevance of machine learning models over time. The validation, feedback, and refinement engine 310 can apply validation data to assess model outputs and integrates feedback from users or automated systems to improve models. Metrics 316 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 300 may be implemented by hardware processors and may communicate via network interfaces or shared storage elements to facilitate data exchange and coordination. The architecture shown in FIG. 3 allows for flexible deployment across various machine learning applications, such as natural language processing, computer vision, or predictive analytics.

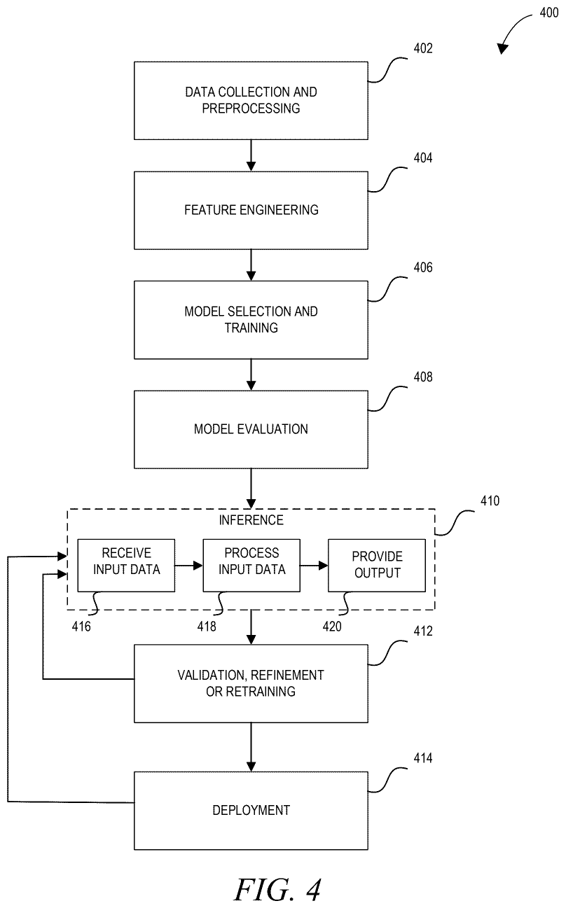

FIG. 4 is a flowchart depicting a machine learning pipeline 400, according to some examples. The machine learning pipeline 400, or parts thereof, may be used to generate a trained machine learning model for use in examples of the present disclosure. In some examples, a system such as the machine learning system 300 of FIG. 3 is used to implement the machine learning pipeline 400.

The machine learning pipeline 400 commences with a data collection and preprocessing stage 402, in which data is acquired, cleaned, or formatted for compatibility with machine learning algorithms. The data collection and preprocessing stage 402 may also involve addressing issues such as duplicate entries, missing values, or data inconsistencies.

During a feature engineering stage 404, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 406 can include selecting an appropriate machine learning algorithm or strategy and training the relevant model on training data. The model selection and training stage 406 may involve splitting the data into training and testing sets, using cross-validation to evaluate the model, and tuning hyperparameters to improve performance. During training, the model may be trained to find features that affect a predicted outcome. The result of the training is a trained machine learning model.

In some examples, techniques such as model quantization, pruning, or knowledge distillation can reduce the computational complexity of a trained model. Quantization involves reducing the precision of weights and activations (e.g., from 52-bit floating-point to 8-bit integers), enabling efficient deployment on hardware-constrained environments such edge devices. Pruning removes redundant or non-contributory connections within a model, thereby reducing memory and processing requirements. Knowledge distillation transfers the learned knowledge of a large, complex model into a smaller, lightweight model.

A model evaluation stage 408 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 4 further shows an inference stage 410, in which a trained model generates outputs on new, unseen data. For example, for each input, at operation 416, the model receives input data (e.g., from external sources, such as real-time sensors, databases, or user-provided queries, or internal sources such as test inputs). At operation 418, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 420.

It is noted that output data may take various forms. In classification AI examples, outputs may include data classifications or probabilities linked to particular classifications. In generative AI examples, outputs may include new content, such as translations, summaries, answers, new media content, or combinations thereof. In some examples, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 400 may also include a validation, refinement, or retraining stage 412. This may include updating a model based on feedback generated from the inference stage 410, such as new data or user feedback. In some examples, validation is performed a separate dataset known as the validation dataset. The validation dataset can be used to tune or fine-tune the hyperparameters of a model, such as the learning rate and the regularization parameter. The hyperparameters may be adjusted to improve the model's performance on the validation dataset.

During deployment stage 414, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some examples, the trained model is deployed on a single device, such as locally on an end user's computing device or on an edge device, as opposed to being deployed on a server system. This may provide lower latency or offline functionality in certain scenarios. Accordingly, various trained models can be deployed as server-based deployments or on-device deployments.

In some examples, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

As mentioned, a generative AI model can generate new content. For example, generative AI can produce text, images, video, audio, code, or synthetic data. In some examples, the generated content may be similar to original data, but not identical.

Some of the techniques or architectures that may be used in generative AI are GANs, Variational autoencoders (VAEs), and transformers. GANs may include two neural networks: a generator and a discriminator. The generator network attempts to create realistic content that can “fool” the discriminator network, while the discriminator network attempts to distinguish between real and fake content. The generator and discriminator networks compete with each other and improve over time. VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models may use attention mechanisms to learn the relationships between different parts of input data (such as words or pixels) and generate output data based on these relationships. In some examples, transformer models can handle sequential data, such as text or speech, as well as non-sequential data, such as images or code.

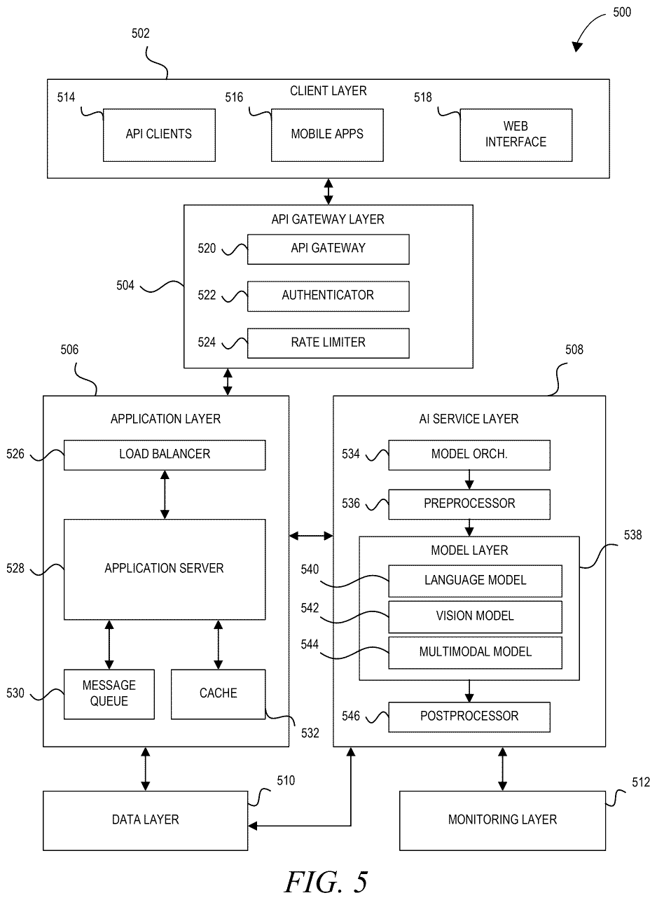

FIG. 5 is a system architecture diagram showing a layered view of an AI integrated system 500, according to some examples. The AI integrated system 500 comprises six example layers: a client layer 502, an API gateway layer 504, an application layer 506, an AI service layer 508, a data layer 510, and a monitoring layer 512.

The client layer 502 provides multiple access points for system interaction. It includes API clients 514, which may enable programmatic access to the capabilities of the AI integrated system 500 or integration with third-party systems and services. Mobile applications 516 facilitate access from mobile applications and devices, for example implementing native mobile protocols while maintaining consistent communication patterns with backend systems. A web interface 518 enables browser-based access to the capabilities of the AI integrated system 500 and may communicate with other layers using, for example, Hypertext Transfer Protocol (HTTP) or Hypertext Transfer Protocol Secure (HTTPS) protocols.

The API gateway layer 504 serves as an entry point for client communications. The API gateway layer 504 comprises an API gateway 520, which may implement routing logic to direct incoming requests to appropriate backend services. An authenticator 522 validates client credentials, for example using industry-standard protocols, such as OAuth 4.0 (Open Authorization 4.0) or JWT (JSON Web Tokens). In some examples, a rate limiter 524 of the API gateway layer 504 operates to prevent system abuse or ensure resource allocation among clients.

The application layer 506 comprises various processing capabilities. In some examples, the application layer 506 includes a load balancer 526 that may distribute incoming requests across multiple application server instances to support resource utilization and system reliability. An application server 528 may implement business or core functional logic of the AI integrated system 500, processing requests and coordinating responses across various system components. In some examples, a message queue 530 facilitates asynchronous processing capabilities, enabling efficient handling of operations, and a cache 532 operates within the application layer 506 to improve response times for frequently requested data.

The AI service layer 508 provides AI capabilities through a structured approach to model deployment and execution. In some examples, the AI service layer 508 includes a model orchestrator 534 that coordinates the execution of one or various AI models, managing resource allocation and implementing routing logic to direct requests to appropriate model instances. A preprocessor 536 may prepare input data for model consumption, implementing transformations, validations, or other preprocessing operations.

FIG. 5 shows the AI service layer 508 as include a model layer 538. The model layer 538 may include multiple model types, including, for example, one or more of: a language model 540 for processing textual input, implementing natural language processing capabilities; a vision model 542 for handling image or video processing tasks; and a multimodal model 544 that combines multiple input types to provide comprehensive analysis capabilities. In some examples, a postprocessor 546 of the AI service layer 508 transforms model outputs into standardized formats suitable for client consumption. The data layer 510 provides persistent storage capabilities.

While not detailed in FIG. 5, it is noted that the data layer 510 may include various components such as a primary database for maintaining transactional data, a vector database for optimizing storage and retrieval of high-dimensional vectors used in AI applications and models of the AI service layer 508, or a file storage component for managing binary data assets.

The monitoring layer 512 may provide observability capabilities across the AI integrated system 500. This may include logging for capturing system events, metrics collection for performance analysis, or distributed tracing for detailed analysis of request flow through the system.

Communication between layers of the AI integrated system 500 may follow defined patterns. External communications may implement appropriate encryption protocols, for example utilizing Transport Layer Security (TLS) or Secure Sockets Layer (SSL) for data protection. Internal communications may use various protocols selected for specific use cases, for example, Hypertext Transfer Protocol version 4 (HTTP/2), gRPC (Google Remote Procedure Call), or proprietary protocols where appropriate.

Referring again to the model layer 538, this layer may incorporate various types of machine learning models. Neural networks may be deployed to implement various architectures suited to specific processing needs. These can include, merely for example, fundamental feedforward neural networks for pattern recognition, convolutional neural networks (CNNs, neural networks that may be specialized for processing visual information), recurrent neural networks (RNNs, neural networks that may be designed for sequential data), transformer networks, or other architectures (e.g., Long Short-Term Memory networks [LSTMs] or Gated Recurrent Units [GRUs]).

A language model such as the language model 540 may use transformer-based architectures (e.g., Bidirectional Encoder Representations from Transformers [BERT], Generative Pre-trained Transformer [GPT] variants, or Text-to-Text Transfer Transformer [T5]) for processing textual data and implementing natural language understanding capabilities. A vision model such as the vision model 542 may employ specialized neural network architectures (e.g., CNNs, Vision Transformers (ViT), or Residual Neural Network (ResNet) variants) for processing visual information and extracting features from images or video streams. A multimodal model such as the multimodal model 544 may implement hybrid architectures (e.g., Contrastive Language-Image Pre-training (CLIP), DALL-E variants, or multimodal transformers) designed to process and correlate information across different input modalities, leveraging ensemble approaches to combine multiple model types using model aggregation or weighted prediction strategies. A multimodal model may combine textual, visual, and other forms of input data to provide analysis and generate integrated outputs that leverage cross-modal understanding capabilities.

The AI service layer 508 may provide both supervised learning models (e.g., decision trees, random forests, or support vector machines) for specific classification and prediction tasks, and unsupervised learning models (e.g., k-means clustering or principal component analysis) for pattern discovery and dimensionality reduction within the data processing pipeline. Probabilistic models (e.g., Bayesian networks or hidden Markov models) may be integrated within the AI service layer 508 to handle uncertainty in decision-making processes, working in conjunction with the preprocessor 536 and postprocessor 546 components to provide probability estimates and confidence metrics for model outputs.

Each model type may be implemented using various deployment strategies, with the model orchestrator 534 managing their execution and resource allocation to ensure adequate performance and efficient system operation. This may include coordinating the deployment and execution of various model types, ensuring efficient resource allocation, and appropriate model selection based on specific task requirements. While in some examples the model layer 538 provides server-based access to one or more models, a model can alternatively (or additionally) be deployed so as to perform inference locally (e.g., at the client layer 502).

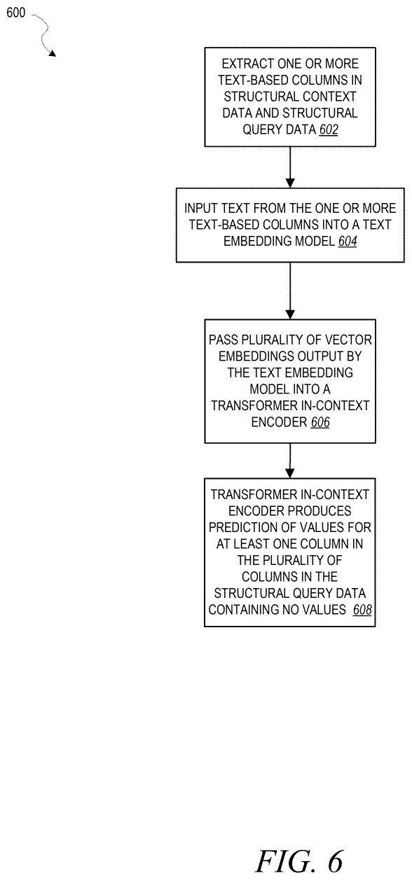

FIG. 6 is a flow diagram illustrating a method 600 for using a neural network to predict values in structural data, in accordance with an example embodiment. At operation 602, one or more text-based columns in structural context data and structural query data are extracted. The structural context data comprising a plurality of columns, each of the plurality of columns in the structural context data containing at least some values (e.g., they are at all at least partially populated). The structural query data comprising a plurality of columns, at least one column in the plurality of columns in the structural query data containing no values (e.g., unpopulated, as these values are going to be predicted).

At operation 604, text from the one or more text-based columns are input into a text embedding model. The text embedding model converts each piece of text data into a vector embedding. The vector embedding represents a geometrical position in a latent vector space such that the geometrical position indicates semantic meaning of a corresponding piece of text data. In an example embodiment, the text embedding model is an LLM.

At operation 606, a plurality of vector embeddings output by the text embedding model are passed into a transformer in-context encoder. At operation 608, the transformer in-context encoder produces, based on the plurality of vector embeddings, a prediction of values for the at least one column in the plurality of columns in the structural query data containing no values.

In an example embodiment, the transformer in-context encoder is part of a neural network comprising an output layer, the output layer comprising a query matrix and a key matrix. The query matrix comprises a first set of embeddings produced through an attention process and the key matrix comprises a second set of embeddings produced through the attention process. In some example embodiments, the output layer further comprises an output matrix formed from a computation of inner products of the query matrix and the key matrix.

In some example embodiments, the neural network is trained using a sigmoid function and by using binary cross-entropy as a loss function. The loss computed by the loss function may be computed elementwise on the query matrix and the key matrix, and then also on an adjacency matrix, and then results are aggregated.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: extracting text data from one or more text-based columns in both structural context data and structural query data, the structural context data comprising a plurality of columns, each of the plurality of columns in the structural context data containing at least some values, the structural query data comprising a plurality of columns, at least one column in the plurality of columns in the structural query data containing no values; inputting the text data into a text embedding model, the text embedding model converting each piece of text data into a vector embedding, the vector embedding representing a geometrical position in a latent vector space such that the geometrical position indicates semantic meaning of a corresponding piece of text data; and passing a plurality of vector embeddings output by the text embedding model into a transformer in-context encoder, the transformer in-context encoder producing, based on the plurality of vector embeddings, a prediction of values for the at least one column in the plurality of columns in the structural query data containing no values.

In Example 2, the subject matter of Example 1 comprises, wherein the text embedding model is a large language model (LLM).

In Example 3, the subject matter of Examples 1-2 comprises, wherein the transformer in-context encoder is a Bidirectional Encoder Representations from Transformers (BERT) model.

In Example 4, the subject matter of Examples 1-3 comprises, wherein the transformer in-context encoder is part of a neural network comprising an output layer, the output layer comprising a query matrix and a key matrix, the query matrix comprising a first set of embeddings produced through an attention process and the key matrix comprising a second set of embeddings produced through the attention process. In Example 5, the subject matter of Example 4 comprises, wherein the output layer further comprises an output matrix formed from a computation of inner products of the query matrix and the key matrix.

In Example 6, the subject matter of Example 5 comprises, wherein the neural network is trained using a sigmoid function and by using binary cross-entropy as a loss function.

In Example 7, the subject matter of Example 6 comprises, wherein loss computed by the loss function is computed elementwise on the query matrix and the key matrix, and then also on an adjacency matrix, and then results are aggregated.

Example 8 is a method comprising: extracting text data from one or more text-based columns in both structural context data and structural query data, the structural context data comprising a plurality of columns, each of the plurality of columns in the structural context data containing at least some values, the structural query data comprising a plurality of columns, at least one column in the plurality of columns in the structural query data containing no values; inputting the text data into a text embedding model, the text embedding model converting each piece of text data into a vector embedding, the vector embedding representing a geometrical position in a latent vector space such that the geometrical position indicates semantic meaning of a corresponding piece of text data; and passing a plurality of vector embeddings output by the text embedding model into a transformer in-context encoder, the transformer in-context encoder producing, based on the plurality of vector embeddings, a prediction of values for the at least one column in the plurality of columns in the structural query data containing no values.

In Example 9, the subject matter of Example 8 comprises, wherein the text embedding model is a large language model (LLM).

In Example 10, the subject matter of Examples 8-9 comprises, wherein the transformer in-context encoder is a Bidirectional Encoder Representations from Transformers (BERT) model.

In Example 11, the subject matter of Examples 8-10 comprises, wherein the transformer in-context encoder is part of a neural network comprising an output layer, the output layer comprising a query matrix and a key matrix, the query matrix comprising a first set of embeddings produced through an attention process and the key matrix comprising a second set of embeddings produced through the attention process. In Example 12, the subject matter of Example 11 comprises, wherein the output layer further comprises an output matrix formed from a computation of inner products of the query matrix and the key matrix.

In Example 13, the subject matter of Example 12 comprises, wherein the neural network is trained using a sigmoid function and by using binary cross-entropy as a loss function.

In Example 14, the subject matter of Example 13 comprises, wherein loss computed by the loss function is computed elementwise on the query matrix and the key matrix, and then also on an adjacency matrix, and then results are aggregated.

Example 15 is a non-transitory machine-readable medium storing instructions which, when executed by one or more processors, cause the one or more processors to perform operations comprising: extracting text data from one or more text-based columns in both structural context data and structural query data, the structural context data comprising a plurality of columns, each of the plurality of columns in the structural context data containing at least some values, the structural query data comprising a plurality of columns, at least one column in the plurality of columns in the structural query data containing no values; inputting the text data into a text embedding model, the text embedding model converting each piece of text data into a vector embedding, the vector embedding representing a geometrical position in a latent vector space such that the geometrical position indicates semantic meaning of a corresponding piece of text data; and passing a plurality of vector embeddings output by the text embedding model into a transformer in-context encoder, the transformer in-context encoder producing, based on the plurality of vector embeddings, a prediction of values for the at least one column in the plurality of columns in the structural query data containing no values.

In Example 16, the subject matter of Example 15 comprises, wherein the text embedding model is a large language model (LLM).

In Example 17, the subject matter of Examples 15-16 comprises, wherein the transformer in-context encoder is a Bidirectional Encoder Representations from Transformers (BERT) model.

In Example 18, the subject matter of Examples 15-17 comprises, wherein the transformer in-context encoder is part of a neural network comprising an output layer, the output layer comprising a query matrix and a key matrix, the query matrix comprising a first set of embeddings produced through an attention process and the key matrix comprising a second set of embeddings produced through the attention process.

In Example 19, the subject matter of Example 18 comprises, wherein the output layer further comprises an output matrix formed from a computation of inner products of the query matrix and the key matrix.

In Example 20, the subject matter of Example 19 comprises, wherein the neural network is trained using a sigmoid function and by using binary cross-entropy as a loss function.

Example 21 is at least one machine-readable medium comprising instructions that, when executed by processing circuitry, cause the processing circuitry to perform operations to implement any of Examples 1-20.

Example 22 is an apparatus comprising means to implement any of Examples 1-20.

Example 23 is a system to implement of any of Examples 1-20.

Example 24 is a method to implement of any of Examples 1-20.

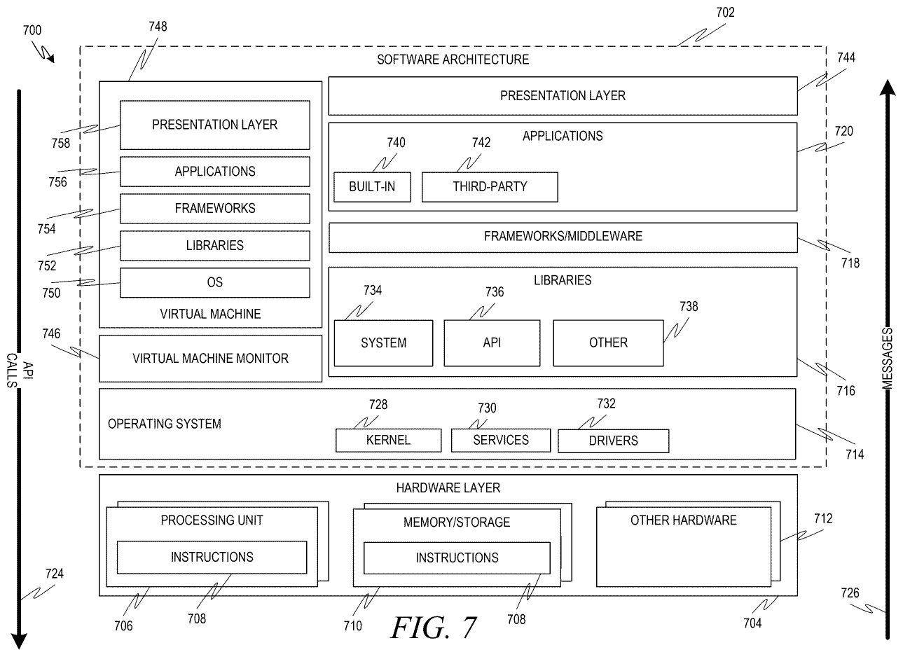

FIG. 7 shows a block diagram 700 showing one example of a software architecture 702 for a computing device. The software architecture 702 may be used in conjunction with various hardware architectures, for example, as described herein. FIG. 7 is merely a non-limiting example of a software architecture, and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 7.

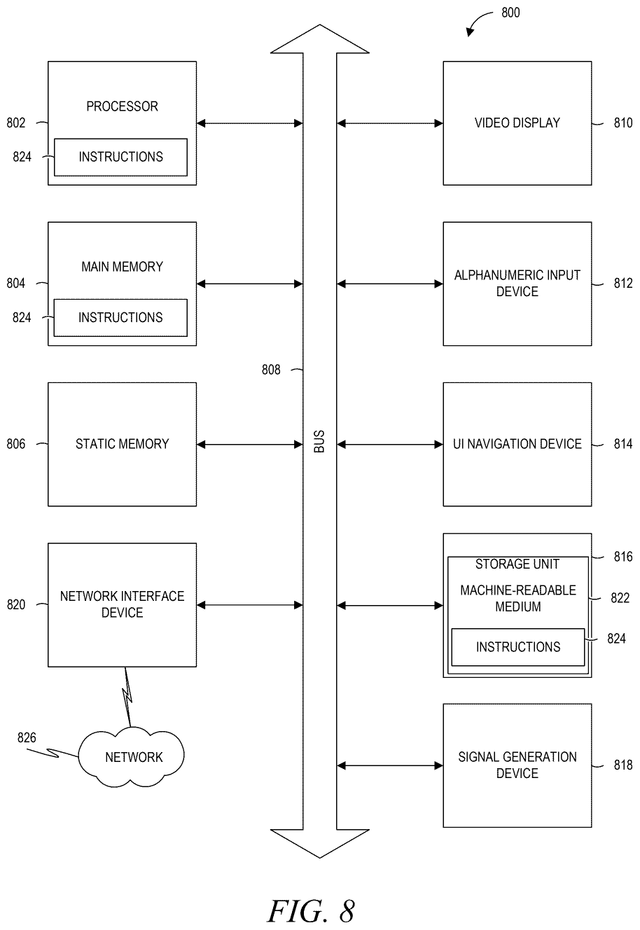

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware 712 which represents any other hardware of the hardware layer 704. Examples of the other hardware 712 include the hardware components shown in FIG. 8.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720, and presentation layer 744. Operationally, the applications 720 and/or other components within the layers may invoke API calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the software architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware 718 may provide a higher-level common infrastructure that may be utilized by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any of the built-in applications as well as a broad assortment of other applications. In a specific example, the third-party application 742 (e.g., an application developed using the Android™ or iOS™ software development kit [SDK] by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built-in operating system functions (e.g., kernel 728, services 730 and/or drivers 732), libraries (e.g., system libraries 734, API libraries 736, and other libraries 738), and frameworks/middleware 718 to create user interfaces to interact with users of the system. Alternatively, or additionally, in some systems, interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine 748 as well as the interface with the host operating system (operating system 714). A software architecture executes within the virtual machine 748 such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

A computer system may include logic, components, modules, mechanisms, or any suitable combination thereof. Modules may constitute either software modules (e.g., code embodied [1] on a non-transitory machine-readable medium or [2] in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 8 shows a block diagram of a machine in the example form of a computer system 800 within which instructions 824 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit [CPU], a graphics processing unit [GPU], or both), a main memory 804, and a static memory 806, which communicate with each other via a bus 808. The computer system 800 may further include a video display unit 810 (e.g., a liquid crystal display [LCD] or a cathode ray tube [CRT]). The computer system 800 also includes an alphanumeric input device 812 (e.g., a keyboard or a touch-sensitive display screen), a user interface (UI) navigation (or cursor control) device 814 (e.g., a mouse), a storage unit 816, a signal generation device 818 (e.g., a speaker), and a network interface device 820.

### Machine-Readable Medium

The storage unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting a machine-readable medium 822.

While the machine-readable medium 822 is shown in FIG. 8 to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with the instructions 824. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 824 may further be transmitted or received over a communications network 826 using a transmission medium. The instructions 824 may be transmitted using the network interface device 820 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or” unless specifically stated otherwise.

What is claimed is:

1. A system comprising:
at least one hardware processor;
a computer-readable medium storing instructions that, when executed by the at least one hardware processor, cause the at least one hardware processor to perform operations comprising:
extracting text data from one or more text-based columns in both structural context data and structural query data, the structural context data comprising a plurality of columns, each of the plurality of columns in the structural context data containing at least some values, the structural query data comprising a plurality of columns, at least one column in the plurality of columns in the structural query data containing no values;
inputting the text data into a text embedding model, the text embedding model converting each piece of text data into a vector embedding, the vector embedding representing a geometrical position in a latent vector space such that the geometrical position indicates semantic meaning of a corresponding piece of text data; and
passing a plurality of vector embeddings output by the text embedding model into a transformer in-context encoder, the transformer in-context encoder producing, based on the plurality of vector embeddings, a prediction of values for the at least one column in the plurality of columns in the structural query data containing no values.

2. The system of claim 1, wherein the text embedding model is a large language model (LLM).

3. The system of claim 1, wherein the transformer in-context encoder is a Bidirectional Encoder Representations from Transformers (BERT) model.

4. The system of claim 1, wherein the transformer in-context encoder is part of a neural network comprising an output layer, the output layer comprising a query matrix and a key matrix, the query matrix comprising a first set of embeddings produced through an attention process and the key matrix comprising a second set of embeddings produced through the attention process.

5. The system of claim 4, wherein the output layer further comprises an output matrix formed from a computation of inner products of the query matrix and the key matrix.

6. The system of claim 5, wherein the neural network is trained using a sigmoid function and by using binary cross-entropy as a loss function.

7. The system of claim 6, wherein loss computed by the loss function is computed elementwise on the query matrix and the key matrix, and then also on an adjacency matrix, and then results are aggregated.

8. A method comprising:
extracting text data from one or more text-based columns in both structural context data and structural query data, the structural context data comprising a plurality of columns, each of the plurality of columns in the structural context data containing at least some values, the structural query data comprising a plurality of columns, at least one column in the plurality of columns in the structural query data containing no values;
inputting the text data into a text embedding model, the text embedding model converting each piece of text data into a vector embedding, the vector embedding representing a geometrical position in a latent vector space such that the geometrical position indicates semantic meaning of a corresponding piece of text data; and
passing a plurality of vector embeddings output by the text embedding model into a transformer in-context encoder, the transformer in-context encoder producing, based on the plurality of vector embeddings, a prediction of values for the at least one column in the plurality of columns in the structural query data containing no values.

9. The method of claim 8, wherein the text embedding model is a large language model (LLM).

10. The method of claim 8, wherein the transformer in-context encoder is a Bidirectional Encoder Representations from Transformers (BERT) model.

11. The method of claim 8, wherein the transformer in-context encoder is part of a neural network comprising an output layer, the output layer comprising a query matrix and a key matrix, the query matrix comprising a first set of embeddings produced through an attention process and the key matrix comprising a second set of embeddings produced through the attention process.

12. The method of claim 11, wherein the output layer further comprises an output matrix formed from a computation of inner products of the query matrix and the key matrix.

13. The method of claim 12, wherein the neural network is trained using a sigmoid function and by using binary cross-entropy as a loss function.

14. The method of claim 13, wherein loss computed by the loss function is computed elementwise on the query matrix and the key matrix, and then also on an adjacency matrix, and then results are aggregated.

15. A non-transitory machine-readable medium storing instructions which, when executed by one or more processors, cause the one or more processors to perform operations comprising:
extracting text data from one or more text-based columns in both structural context data and structural query data, the structural context data comprising a plurality of columns, each of the plurality of columns in the structural context data containing at least some values, the structural query data comprising a plurality of columns, at least one column in the plurality of columns in the structural query data containing no values;
inputting the text data into a text embedding model, the text embedding model converting each piece of text data into a vector embedding, the vector embedding representing a geometrical position in a latent vector space such that the geometrical position indicates semantic meaning of a corresponding piece of text data; and
passing a plurality of vector embeddings output by the text embedding model into a transformer in-context encoder, the transformer in-context encoder producing, based on the plurality of vector embeddings, a prediction of values for the at least one column in the plurality of columns in the structural query data containing no values.

16. The non-transitory machine-readable medium of claim 15, wherein the text embedding model is a large language model (LLM).

17. The non-transitory machine-readable medium of claim 15, wherein the transformer in-context encoder is a Bidirectional Encoder Representations from Transformers (BERT) model.

18. The non-transitory machine-readable medium of claim 15, wherein the transformer in-context encoder is part of a neural network comprising an output layer, the output layer comprising a query matrix and a key matrix, the query matrix comprising a first set of embeddings produced through an attention process and the key matrix comprising a second set of embeddings produced through the attention process.

19. The non-transitory machine-readable medium of claim 18, wherein the output layer further comprises an output matrix formed from a computation of inner products of the query matrix and the key matrix.

20. The non-transitory machine-readable medium of claim 19, wherein the neural network is trained using a sigmoid function and by using binary cross-entropy as a loss function.
